(19) United States
(12) Patent Application Publication
(10) Pub. No.: US 2026/0346453 A1
(43) Pub. Date: Nov. 5, 2026

(54) AUTOMATIC FLANGE BOLTING ROBOT

(71) Applicant: Total Marine Technology PTY LTD, Bibra Lake (AU)

(72) Inventors: Peter Ivanac, Bibra Lake (AU); Glenn Van Ballegooij, Bibra Lake (AU); Kienan Warder, Bibra Lake (AU)

(73) Assignee: Total Marine Technology PTY LTD, Bibra Lake, WA (AU)

(21) Appl. No.: 19/521,714

(22) PCT Filed: Feb. 5, 2024
(86) PCT No.: PCT/AU2024/050068

§ 371 Date: Mar. 20, 2026

(30) Foreign Application Priority Data
Sep. 21, 2023 (AU) 2023903044

(51) Int. Cl. B25J 9/16; B25J 9/06; B25J 13/06; B25J 15/00; B25J 19/02

(52) U.S. Cl. CPC B25J 9/1687; B25J 9/06; B25J 13/06; B25J 15/0019; B25J 19/023

(57) ABSTRACT

A robotic apparatus for applying a torque flange bolt is described. The apparatus includes an attachment portion arranged to releasably attach to the first member by means of magnetic catches. A first arm extends from the attachment portion, and is arranged to rotate about the attachment portion. A second arm extends from the first arm, with a torque tool at its end. The second arm can be remotely manipulated to located the torque tool about a flange bolt.

### FIELD OF THE INVENTION

The present invention relates to a automatic or at least remotely operated device, such as a robotic device, for bolting and/or unbolting flanges such as those used to seal pressure vessels.

### BACKGROUND TO THE INVENTION

Flanges are typically used to connect fluid carrying equipment including tanks, pressure vessels, pipes and other process equipment. A typical arrangement involves two flanges being brought together, often with a gasket or other seal in between; a plurality of bolts passing through aligned apertures in the flanges; and nuts being tightened onto the bolts to force the flanges together and to form a seal.

In the case of large pressure vessels containing hot and or/corrosive liquids, there may be in the order of 50 to 60 bolts around the circumference of a single flanged connection.

Disconnection of such a flanged connection, whether for inspection, service, or other reason, can present several difficulties. Where the flanged connection is to a pressurised environment, there is potential risk to a worker loosening bolts. The flanged connection may be in a position where access is difficult, either to the entire connection or to some of the nuts. Removing the bolts may result in one potentially heavy member becoming free, which can be hazardous. Flanged connections often involve working at heights, which can present a risk of physical injury, and the handling of heavy equipment which can risk strain injuries and also limit the range of people able to undertake this work.

For at least these reasons, it is considered desirable to employ an apparatus to enable a flange connection to be loosened in a safe manner. The present invention has been created in light of this desire.

### SUMMARY OF THE INVENTION

According to one aspect of the present invention there is provided an automatic and/or remotely operable apparatus for applying a torque to a nut on a flanged connection, the flanged connection being between a first member and a second member, the apparatus including:
an attachment portion arranged to releasably attach to the first member;
a first arm extending from the attachment portion;
a first actuator associated with the first arm, the first actuator arranged to effect rotation of the first arm relative to the attachment portion;
a second arm extending from an outer end of the first arm;
a torque applying means mounted to an outer end of the second arm;
at least one second actuator associated with the second arm, the second actuator(s) arranged to effect movement of torque applying means relative to the first arm; and
a control means, the control means arranged to effect remote operation of the first actuator, the second actuator(s), and the torque applying means.

In one embodiment of the invention, an inner second actuator effects linear movement of the second arm along the first arm, and an outer second actuator effects linear movement of the torque applying means along the second arm. It is preferred that the second arm is perpendicular to the first arm.

In an alternative embodiment of the invention, the second arm may have a first portion and a second portion, with second actuators effecting rotation of the first portion relative to the first arm, rotation of the second portion relative to the first portion, and rotation of the torque applying means relative to the second portion.

It is preferred that the torque applying means includes an associated restraining arm, the restraining arm arranged to extend across the flanged connection, whereby the torque applying means is arranged to apply a torque to either a nut or a bolt associated with the first member and the restraining arm is arranged to restrict rotation of a corresponding bolt or nut associated with the second member. It will be appreciated that the torque applying and rotation restricting functions may be swapped between the first and second members respectively.

The restraining arm may be arranged to pivot relative to the torque applying means, with a pivot axis perpendicular to a torque applying axis. It is preferred that the restraining arm is resiliently biased to a position whereby it extends in a generally axial direction relative to the torque applying means.

In an alternative embodiment, the restraining arm may include an extension means arranged to alter a distance between a nut-engaging portion and a bolt-engaging portion of the torque applying means. The extension means may be a hydraulic ram or a pneumatic ram.

The torque applying means may include a detection means for determining the position of bolts and/or nuts. The detection means may include a camera.

The attachment portion may include a plurality of attachment arms arranged to extend radially from a central hub. In this embodiment the attachment arms are preferably angularly spaced around the central hub.

The attachment arms may each have a magnetic switch at an outer end thereof for magnetic attachment to the first member.

It is envisioned that the torque applying means may be a pneumatic torque tool, a hydraulic torque tool, or an electric torque tool. Other tools may be possible.

### BRIEF DESCRIPTION OF THE DRAWINGS

It will be convenient to further describe the invention with reference to preferred embodiments of the present invention. Other embodiments are possible, and consequently the particularity of the following discussion is not to be understood as superseding the generality of the preceding description of the invention. In the drawings:

FIG. 1 is a schematic view of a remotely operable apparatus for applying a torque to a nut on a flanged connection shown during use;

FIG. 2 is a rear perspective of the remotely operable apparatus of FIG. 1;

FIG. 3 is a front perspective of the remotely operable apparatus of FIG. 1;

FIG. 4 is a lower perspective of the remotely operable apparatus of FIG. 1;

FIG. 5 is a closeup from above of a torque tool within the remotely operable apparatus of FIG. 1;

FIG. 6 is a closeup from below of the torque tool of FIG. 5; and

FIG. 7 is a closeup of an alternative torque tool for use within the remotely operable apparatus of FIG. 1.

### DETAILED DESCRIPTION OF PREFERRED EMBODIMENTS

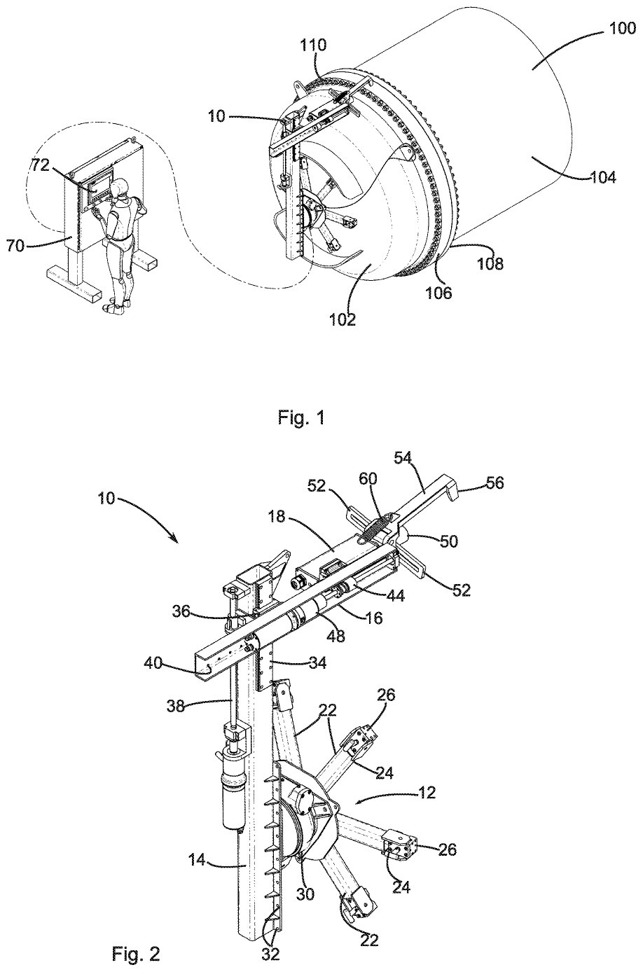

FIG. 1 shows a remotely operable apparatus, hereinafter referred to as a robot 10, attached to a pressure vessel 100. The pressure vessel 100 has a first member being an endcap 102 and a second member being a body 104. The endcap 102 and the body 104 are connected by means of a flanged connection, being a first flange 106 about the endcap 102 and a second flange 108 about the body 104, the first flange 106 and the second flange 108 being bolted together by bolts 110.

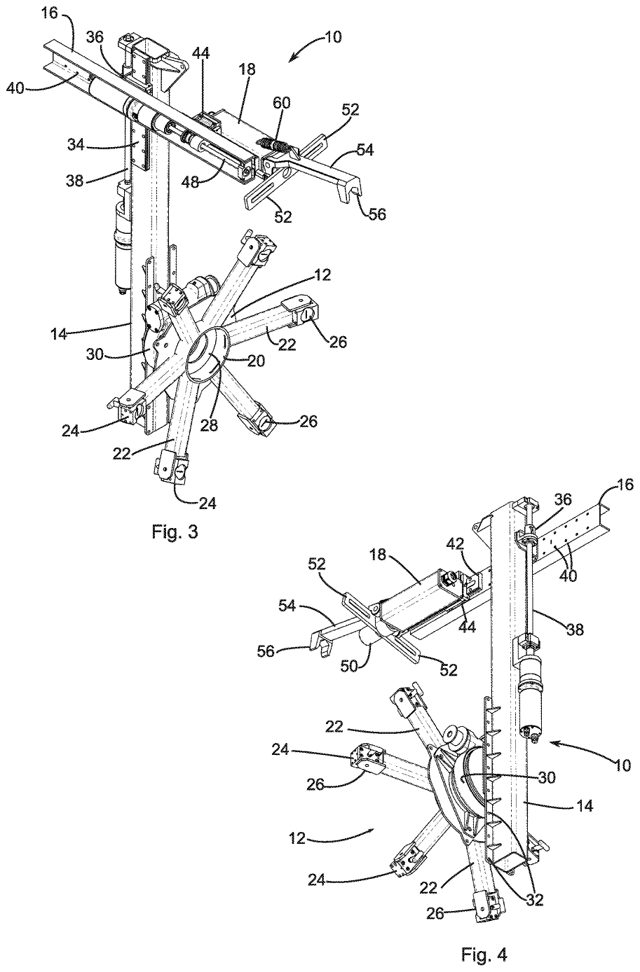

FIGS. 2 to 4 show the robot 10 in greater detail. The robot 10 has an attachment portion 12, a first arm being a radial arm 14, a second arm being an axially extending arm 16, and a torque applying means being a torque tool 18.

The attachment portion 12 comprises a hub 20 from which six attachment arms 22 extend. The hub 20 is circular, defining a central axis and a radial direction. The attachment arms 22 are generally radial, but are angled towards the central axis by about 15°. Each attachment arm 22 has an outer end 24. It will be appreciate that the outer ends 24 are located forward of a plane defined by the hub 20.

The attachment arms 22 are equiangularly spaced about the hub 20.

A magnetic switch 26 is pivotally mounted to the outer end 24 of each attachment arm 22, the magnetic switches 26 being oriented away from the hub 20.

The hub 20 has an annular portion from which the attachment arms 22 extend, the annular portion presenting a cylindrical recess 28 open at a front side of the hub 20.

A rotary axis slew drive 30 is fixed to the rear of the hub 20. The radial arm 14 is mounted to the rotary axis slew drive 30, and extends away from the hub 20 in the radial direction. The rotary axis slew drive 30 represents a first actuator of the robot 10, permitting and controlling 360° rotation of the radial arm 14 about the axis of the hub 20.

The radial arm 14 includes a plurality of mounting apertures 32 by means of which it can be mounted to the rotary axis slew drive 30. The effective radial length of the radial arm 14 can be varied by the choice of mounting apertures 32 employed.

A first linear rail system having a first rail 34 is fixed to an outer end of the radial arm 14. The axially extending arm 16 is mounted to a first carriage 36 located on the first rail 34, and extends away from the first carriage 36 in the forward axial direction; that is, perpendicular to the radial arm 14.

The radial arm 14 includes an inner second actuator being a radially aligned linear screw drive 38. The radially aligned linear screw drive 38 extends past the first rail 34, and is fixed to the first carriage 36. The radially aligned linear screw drive 38 controls the radial position of the first carriage 36 and thus the radial position of the axially extending arm 16.

The axially extending arm 16 includes a plurality of mounting apertures 40 by means of which it can be mounted to the first carriage 36. The effective axial length of the axially extending arm 16 can be varied by the choice of mounting apertures 40 employed.

A second linear rail system having a second rail 42 is fixed to a front end of the axially extending arm 16. The torque tool 18 is mounted to a second carriage 44 located on the second rail 42, and extends away from the second carriage 44 in the forward axial direction; that is, parallel to the axially extending arm 16.

The axially extending arm 16 includes an outer second actuator being an axially aligned linear screw drive 48. The axially aligned linear screw drive 48 extends past the second rail 42, and is fixed to the second carriage 44. The axially aligned linear screw drive 48 controls the axial position of the second carriage 44 and thus the axial position of the torque tool 18.

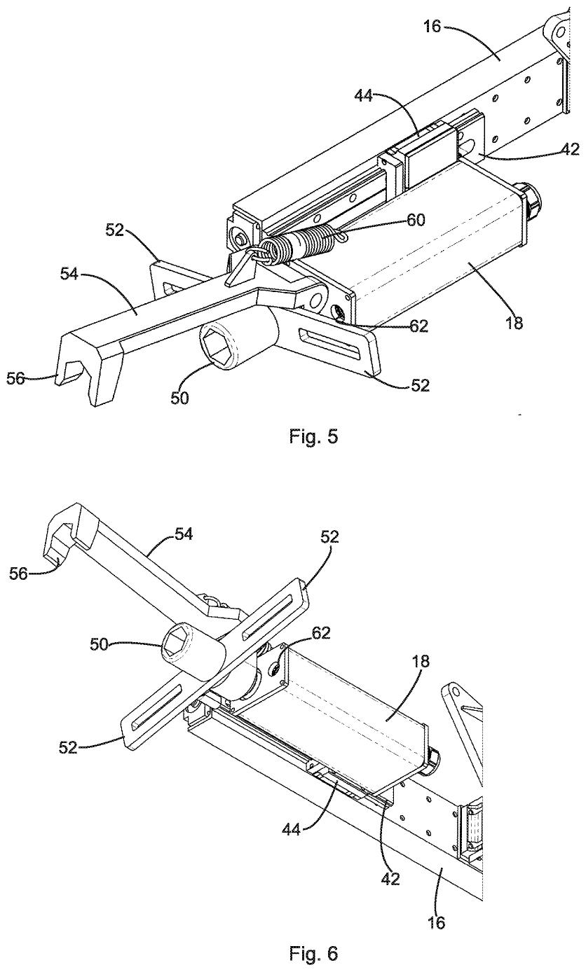

The torque tool 18 has a torque applying member. In a first embodiment shown in FIGS. 1 to 6, the torque applying member is a socket 50 which extends from a front end of the torque tool 18 in the axial direction. It will be appreciated that the socket 50 is sized to engage with either the head or associated nut of a bolt 110.

Torque arms 52 extend away from the socket 50 in a radial direction relative to the socket 50.

A restraining arm 54 is attached to a front face of the torque tool 18, and arranged to pivot about a transverse axis relative to the socket 50. The restraining arm 54 extends in a forward direction from the torque tool 18. The restraining arm 54 has an outermost end from which a rotation restricting portion 56 extends in a generally radial direction.

The rotation restricting portion 56 is sized and shaped to engage with either the head or associated nut of a bolt 110.

In use, the rotation restricting portion 56 is axially aligned with the socket 50, with the restraining arm 54 being spaced from an axis of the socket 50. It will be appreciated that the restraining arm can locate outside the flanges 106, 108 while the socket 50 and rotation restricting portion 56 respectively engage the head and associated nut of a bolt 110. When torque is applied by the socket 50 to the head of a bolt 110, the rotation restricting portion 56 acts to prevent the associated nut from rotating along with the bolt 110.

A resilient biasing means in the form of a compression spring 60 extends between the torque tool 18 and the restraining arm 54. The compression spring 60 acts to allow the restraining arm 54 to pivot relative to the torque tool 18, but biases it to return to the position shown in the drawings; that is, a position wherein the rotation restricting portion 56 is axially aligned with the socket 50.

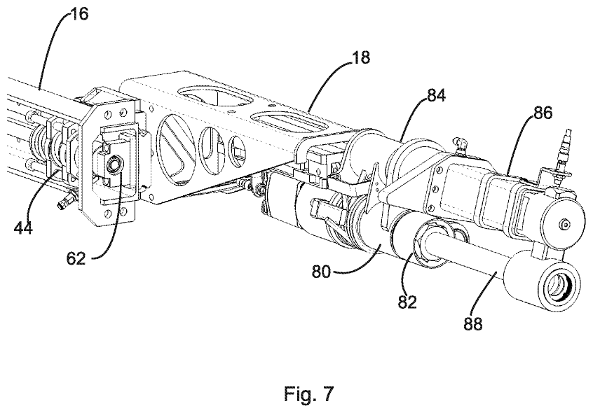

In an alternative embodiment shown in FIG. 7, the torque applying member includes a first socket 80 which is arranged to face a second socket 82. The first socket 80 extends from a front end of the torque tool 18 in the axial direction. It will be appreciated that the first socket 80 is sized to engage with either the head or associated nut of a bolt 110, with the second socket 82 being sized to engage with the other of the head or associated nut of the bolt 110.

A restraining arm 84 extends in an axial direction from a front face of the torque tool 18, and includes a extension means 86, which is preferably a hydraulic ram or a pneumatic ram. The second socket 82 is fixed to a supporting arm 88, which in turn is mounted to an outer end of the extension means 86.

In use, the extension means 86 is operated to move the second socket 82 in an axial direction away from the first socket 80, thus creating a gap between the first socket 80 and the second socket 82. This gap can be located over the flanges 106, 108, such that the first socket 80 can be arranged to face a head of a bolt 110 with the second socket facing an associated nut. Once appropriately located, the extension means 86 can be operated to move the second socket 82 towards the first socket 80, allowing both first and second sockets 80, 82 to engage with their respective bolt 110 and nut. In this embodiment torque is applied by the first socket 80 to the bot 110, with the second socket 82 acting to restrain rotation of the associated nut.

The torque tool 18 includes a detection means being a camera 62 located within its front face.

The magnetic switches 26, the rotary axis slew drive 30, the radially aligned linear screw drive 38, the axially aligned linear screw drive 48, the torque tool 18 and the camera 62 are all connected to a control means being an electronic controller 70 having a human machine interface (HMI) including a touch screen 72. In this way a user can operate the robot 10 while remaining a safe distance away from the pressure vessel 100. Indeed, the robot can be programmed to operate automatically with no ongoing need for the user.

In use, a crane or similar lifting means can be used to bring the robot 10 against the endcap 102 of the pressure vessel 100. It is preferred that the robot 10 is positioned so that the hub 20 is generally central to the endcap 102, but this is not essential. The magnetic switches 26 can then be actuated to connect the attachment portion 12 to the endcap 102.

The radially aligned linear screw drive 38 can be actuated to extend the torque tool 18 beyond the radial extent of the flanges 106, 108. The axially aligned linear screw drive 48 can then be actuated to locate the socket 50 (or the first socket 80) on one axial side of the flanges 106, 108 and the rotation restricting portion 56 (or the second socket 82) on the other axial side of the flanges 106, 108.

The rotary axis slew drive 30 and the radially aligned linear screw drive 38 are then operated to bring the socket 50 or first socket 80 into alignment with a bolt 110. The camera 62 can be used to determine the correct position of the socket 50, 80. When the axis of the socket 50, 80 is correctly aligned, the axially aligned linear screw drive 48 is used to move the socket 50, 80 onto the head of the bolt 110. In the first embodiment the rotation restricting portion 56 ‘rides over’ the flange 108 as the socket 50 moves forward, before being urged by the compression spring 60 into engagement with the associated nut of the bolt 110.

The torque tool 18 can then be operated to apply an appropriate torque to the bolt 110, causing relative rotation of the bolt 110 and its associated nut.

The axially aligned linear screw drive 48 can then withdraw the socket 50, 80, and the rotary axis slew drive 30 can be operated to move the torque tool onto the next bolt 110. The operation can then be repeated.

It will be appreciated that once the robot 10 has been attached then the controller 70, using information from the camera 62, can be programmed to automatically move from one bolt to another.

Although the robot has been described in connection with a flanged connection of an endcap for a pressure vessel, it will be appreciated that it can be equally used with other flanged connections such as pipe connection and tank connections.

Modifications and variations as would be apparent to a skilled addressee are deemed to be within the scope of the present invention. For instance, although the embodiment of the drawing features perpendicular arms and associated linear actuators, it will be appreciated that an articulated robot arm could be employed in an alternative embodiment.

What is claimed is:

1. A remotely operable apparatus for applying a torque to a bolt or nut on a flanged connection the flanged connection being between a first member and a second member, the apparatus including:
an attachment portion arranged to releasably attach to the first member;
a first arm extending from the attachment portion;
a first actuator 30 associated with the first arm, the first actuator arranged to effect rotation of the first arm relative to the attachment portion;
a second arm extending from an outer end of the first arm;
a torque applying means mounted to an outer end of the second arm;
at least one second actuator associated with the second arm, each second actuator arranged to effect movement of the torque applying means relative to the first arm; and
a control means, the control means arranged to effect remote operation of the first actuator, each second actuator, and the torque applying means.

2. The apparatus of claim 1, wherein an inner second actuator effects linear movement of the second arm along the first arm, and an outer second actuator effects linear movement of the torque applying means along the second arm.

3. The apparatus of claim 2, wherein the second arm is perpendicular to the first arm.

4. The apparatus of claim 1, wherein the second arm has a first portion and a second portion, with second actuators effecting rotation of the first portion relative to the first arm, rotation of the second portion relative to the first portion, and rotation of the torque applying means relative to the second portion.

5. The apparatus of claim 1, wherein the torque applying means includes an associated restraining arm the restraining arm arranged to extend across the flanged connection 106, 108, whereby the torque applying means 18 is arranged to apply a torque to either a nut or a bolt 110 associated with the first member and the restraining arm is arranged to restrict rotation of a corresponding bolt or nut associated with the second member.

6. The apparatus of claim 1, wherein the torque applying means includes an associated restraining arm, the restraining arm arranged to extend across the flanged connection whereby the torque applying means is arranged to apply a torque to either a nut or a bolt associated with the second member and the restraining arm is arranged to restrict rotation of a corresponding bolt or nut associated with the first member.

7. The apparatus of claim 5, wherein the restraining arm is arranged to pivot relative to the torque applying means.

8. The apparatus of claim 7, wherein the restraining arm is arranged to pivot about a pivot axis, and the torque applying means is arranged to apply a torque along a torque axis, the pivot axis being perpendicular to the torque axis.

9. The apparatus of claim 7, wherein the restraining arm is resiliently biased to a position whereby it extends in a generally axial direction relative to the torque applying means.

10. The apparatus of claim 5, wherein the restraining arm includes an extension means arranged to alter a distance between a nut-engaging portion and a bolt-engaging portion of the torque applying means.

11. The apparatus of claim 10, wherein the extension means is a hydraulic ram or a pneumatic ram.

12. The apparatus of claim 1, wherein the torque applying means includes a detection means for determining the position of bolts and/or nuts.

13. The apparatus of claim 12, wherein the detection means includes a camera.

14. The apparatus of claim 1, wherein the attachment portion includes a plurality of attachment arms arranged to extend radially from a central hub.

15. The apparatus of claim 14, wherein the attachment arms are angularly spaced around the central hub.

16. The apparatus of claim 14, wherein the attachment arms each have a magnetic switch at an outer end thereof for magnetic attachment to the first member.

17. The apparatus of claim 1, wherein the torque applying means is a pneumatic torque tool or a hydraulic torque tool.

18. The apparatus of claim 6, wherein the restraining arm is arranged to pivot relative to the torque applying means.

19. The apparatus of claim 18, wherein the restraining arm is arranged to pivot about a pivot axis, and the torque applying means is arranged to apply a torque along a torque axis, the pivot axis being perpendicular to the torque axis.

20. The apparatus of claim 18, wherein the restraining arm is resiliently biased to a position whereby it extends in a generally axial direction relative to the torque applying means.

21. The apparatus of claim 6, wherein the restraining arm includes an extension means arranged to alter a distance between a nut-engaging portion and a bolt-engaging portion of the torque applying means.

22. The apparatus of claim 21, wherein the extension means is a hydraulic ram or a pneumatic ram.
